(19) United States
(12) Patent Application Publication
(10) Pub. No.: US 2010/0036922 A1
(43) Pub. Date: Feb. 11, 2010

(54) System for Email Advertising

(76) Inventors: Sean Stafford, Louisville, KY (US); Dan Kimball, Louisville, KY (US)

Correspondence Address: GREENBERG & LIEBERMAN, LLC, 2141 WISCONSIN AVE, N.W., SUITE C-2, WASHINGTON, DC, 20007, US

(21) Appl. No.: 12/465,417

(22) Filed: May 13, 2009

Related U.S. Application Data
(63) Continuation-in-part of application No. 12/186,255, filed on Aug. 5, 2008.

(51) Int. Cl. G06F 15/16

(52) U.S. Cl. 709/206; 707/3

(57) ABSTRACT

A system that bounces misdirected electronic mails for notification and monetization purposes or otherwise submits a series 550-error email, via a computer, back to the original sender. The system also relates to breaking down, collecting, and analyzing specific keywords included in sent emails where value is assigned to such keywords, which in turn compares the subject category that is most relevant to that email. From there, the advertisements are pulled from this subject category to include within the particular email. In this manner, the advertisements are tailored to individual sent emails based on the content contained within the email message.

### STATEMENT OF PRIORITY

The following application is a continuation-in-part of U.S. utility patent application Ser. No. 12/186,255, which was filed on 5 Aug. 2008. Priority is hereby claimed.

### FIELD OF THE PRESENT INVENTION

The present invention relates to a system that bounces electronic mails for notification and monetization purposes or otherwise submits a series 550-error email back to the original sender. The present invention presents a system of notification while also providing avenues for monetization and advertising to be included.

### BACKGROUND OF THE PRESENT INVENTION

US publication 2003/0110224 A1 filed by Cazier et al. Jun. 23, 2003 is a system that includes a computer network, a server, and a sender computer and allows intended recipients of bounced emails to retrieve their messages. Cazier detects bounced emails by comparing its message to sent email messages, in the case of a match the system posts at least a portion to a server and sends a notification to the intended recipient. The intended recipient may then retrieve the bounced email from the server. By contrast the present invention in no way contemplates notification of the intended recipient. Furthermore, the present invention generates a response, when warranted, to the sending party based on the content of the sending party's initial sent email. Also, emails in the present invention will not be bounced, as is the case with Cazier. It also should be noted that in contrast to Cazier, the present invention utilizes an untapped source of emails to effectively monetize them. So unlike Cazier, the present invention captures and then monetizes emails that otherwise would have bounced if they were not parked within the domain system. Moreover, unlike Cazier, the present invention parks a domain's mail exchange (MX) record, something that has never been done.

U.S. Pat. No. 6,389,455 issued to Fuisz on May 14, 2002 is a method and apparatus that establishes a hub to route messages sent to a user to the user's pre-selected forwarding email address(es). Fuisz requires that the sender have only the address of the hub to send a message to the user's pre-selected email address. By contrast, the present invention does not contemplate determining the intended recipient's correct email address, but rather generates a response to the sending party when warranted based on the content of the message which was sent. In contrast to Fuisz, the present invention utilizes an untapped source of emails to effectively monetize them. So unlike Fuisz, the present invention captures and then monetizes emails that otherwise would have bounced if they were not parked within the domain system. Moreover, unlike Fuisz, the present invention parks a domain's mail exchange (MX) record.

U.S. Pat. No. 6,965,919 issued to Woods et al. Nov. 15, 2005 is a method for detecting unsolicited electronic mail distributed in bulk. Woods creates fingerprints of emails by dividing emails into sections that are represented by code smaller than the section. Unsolicited electronic mail distributed in bulk is determined using these fingerprints. The present invention is vastly different in that the present invention utilizes an untapped source of emails to effectively monetize them. So unlike Woods, the present invention captures and then monetizes emails that otherwise would have bounced if they were not parked within the domain system. Again, unlike Woods and all other items out there, the present invention parks a domain's mail exchange (MX) record.

US publication 2008/0065761 filed by Wilson on Sep. 11, 2006 is a method, application, and computer program for managing messages rejected by an email server where the problem on the email server and an email identification are identified from a message for storing information about the message in response to the message being rejected and this information along with notification that a problem has occurred on an email server causing the message to be rejected is sent to the sending party. The present invention, however, identifies relevant content via keywords from the text of the message that was received by the sender, and, using this relevant content as input, generates an output that is sent to the sending party when warranted. Also in contrast to Wilson, the present invention utilizes an untapped source of emails to effectively monetize them. So unlike Wilson, the present invention captures and then monetizes emails that otherwise would have bounced if they were not parked within the domain system. Moreover, unlike Wilson, the present invention parks a domain's mail exchange (MX) record.

US publication 2008/0005355 filed by Craft et al. on Jun. 30, 2006 is a method, application, and computer program for managing a response to an email by a hidden recipient. A hidden recipient manager detects a request made by a hidden recipient to respond to an electronic communication and warns the hidden recipient that the request to respond is addressed to a recipient other than the original sender and thus is unaware of receipt by the hidden recipient. By contrast the present invention does not contemplate notifying any hidden recipient that a response to an email may reveal its identity. Also in contrast to Craft, the present invention utilizes an untapped source of emails to effectively monetize them. So unlike Craft, the present invention captures and then monetizes emails that otherwise would have bounced if they were not parked within the domain system. Moreover, unlike Craft, the present invention parks a domain's mail exchange (MX) record.

### SUMMARY OF THE PRESENT INVENTION

Internet domain names are leased from the central registry, which is a server, or in other words, a computer. When the yearly lease on a domain name lapses, the domain name goes back into the available pool of domain names that can be registered by any other entity. When a new entity registers a domain name that had its registration lapse previously, sometimes the new registrant will receive emails on a computer meant for the former owner of the domain name.

In a lot of cases these emails will be bounced back to the original sender with a generic error message, or possibly no error or notification message at all.

The present invention utilizes these misdirected emails, received on a computer, that a domain name receives as an avenue of monetization. The process for this monetization works as follows:
1.) The MX record of a domain name is pointed to the present invention either via CNAME or an A record. These records will be pointing to the present invention's SMTP relay servers.
2.) Any emails that are sent to any email address on a domain name that is pointed to the present invention will trigger a notification of an incoming email on the present invention, the present invention hosted on server systems that are computers that are connected to the World Wide Web.
3.) The invention will then trigger a bounce message, generated ultimately via a computer, via a series 550 error to announce to the original sender that there has been a problem getting the email to the intended recipient.
4.) Included in this series 550 error is a URL. Upon going to this URL in a web browser, the user browsing the page will be given additional information as to why the sending of the email message failed. If the invention is able to provide it, the invention will give a detailed reason why the message failed to reach its intended destination.
5.) Also included in the URL will be the domain name itself. Once this special URL (along with the appended domain name) is inputted into a web browser, the user is taken to a web page that extrapolates the keywords in the domain name.
6.) Once the keywords of a domain name have been identified and extracted from the specialized URL that is created by the present invention, the keywords of the domain name are used as a special identifier for the advertisements that are placed in or around the website that the user is taken to. These advertisements are displayed in relationship to those keywords. With this implementation, related advertisements are shown in conjunction with what the original sender may have been emailing about.

The present invention ultimately serves to break down and analyze incoming emails coming into a computer so that advertisements can be better targeted and placed within such emails while also allowing the converted information to be tracked. An initial step is that a domain name must be parked within the system. Ultimately, the present invention utilizes an untapped source of emails to effectively monetize them. In short, the present invention captures and then monetizes emails that otherwise would have bounced if they were not parked within the domain system. The present invention captures an email and passes it to the user's account to be checked to ensure that the domain is actually parked within the confines of the system. A content filter receives the email and strips it of all common words such as “the” and “it.” These common words are populated in a dictionary file and the common words are removed when matched to those words in the dictionary file. A keyword matcher then receives the remaining email content and runs it through a second dictionary database where keywords are assigned a numerical value.

In other words, once the system receives an email, the system will parse the email body and scan for specific keywords. These keywords can relate to multiple categories. For example, the keyword “computer” may relate to IT or programming. Each keyword is copied over to a found link and a point for each instance of that keyword is assigned. From there, the system of the present invention compares which category has the most points associated with the body of the email. This is to provide information as to what is the most relevant category to the email. Advertisements are pulled from this category.

For a domain name to be parked or monetized via the system of the present invention, the domain itself must have its mail exchange records resolving to the email-parking platform of the present invention. The mail exchange is hereinafter referred to as MX. The present invention affords the system with the ability to resolve DNS servers to a parking system and let the money be derived from the advertisements that are displayed in the user's browser. On the same level relating to email parking, the system is streamlined by permitting the operator to resolve the MX record to the system of the present invention and then add their domain to their control panel in order to derive money. It also should be reiterated that the present invention parks a domain's MX record.

### BRIEF DESCRIPTION OF THE DRAWINGS

FIG. 1 is a flow chart detailing the system of the present invention.

FIG. 2 is a flow chart relating to the message processing of the present invention.

FIG. 3 is a flow chart detailing the monetization process of the preferred embodiment of the present invention.

### DETAILED DESCRIPTION OF THE PREFERRED EMBODIMENT

The present invention relates to a system that bounces (submits a series 550 error email back to the original sender) electronic mails for notification and monetization purposes. Relating to notification, when a misdirected email is sent to the invention, the invention is notified of an incoming email and then “bounces” that email back to the original sender. Within this bounce message is contained a brief description of the reason for the series 550 error, along with a URL that the browser can go to in order to get more complete information as to why the electronic message has bounced. On this page that the URL points to, advertisements will surround the text that describes the reason for the series 550 error. The advertisements and avenues of monetization can include, but are not limited to: cost per action, pay per click, pop-ups, pop-unders, the dropping of cookies for later advertisement identification, pixilation ads, and other forms of monetization.

The present invention also relates to a system that analyzes specific keywords from sent emails and assigns value to such keywords, which in turn compares which subject category is most relevant to that email. From there, the present invention pulls advertisements from this subject category to include within the particular email. In this manner, the present invention tailors advertisements to individual sent emails based on the content contained within the email message.

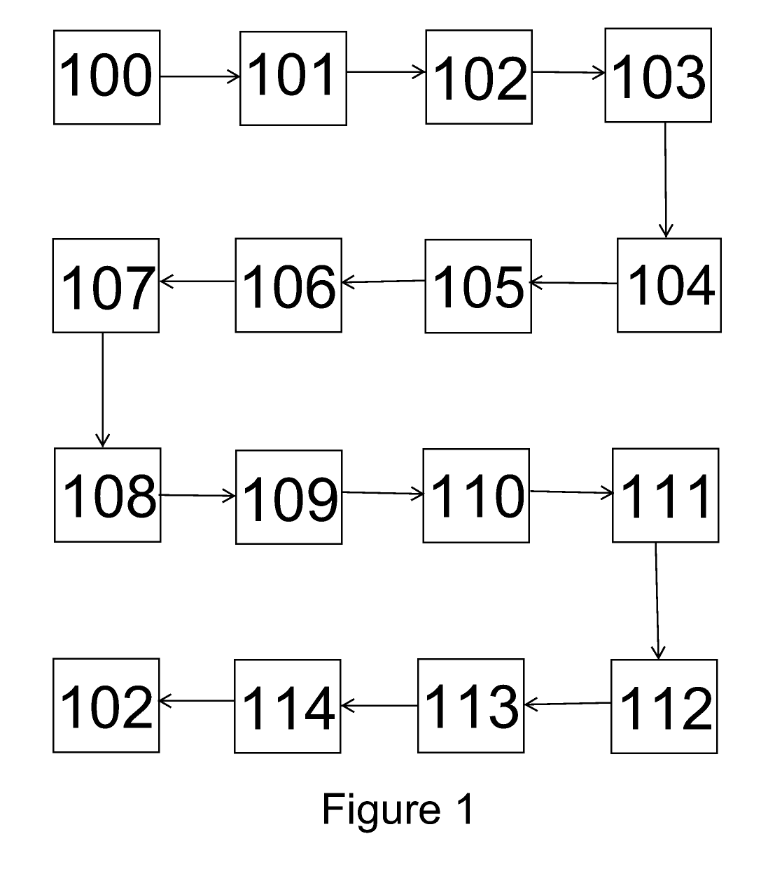

FIG. 1 offers a more detailed description of the system of the present invention. For a domain name to be parked or monetized via the system of the present invention, the domain itself must have its mail exchange records resolving to the email-parking platform of the present invention. The mail exchange is hereinafter referred to as MX. The MX records are recorded, changed, and updated at the registrar where the domain is registered, or at a third party system (100). All email sent to the domain's MX record is captured (101) and routed through to the beginning stages of the email-parking platform. From there, the email is passed off to the user's account (102), which then starts the process of filtering emails. The user's account is the backend area where the domain names that are currently hosted on the email-parking system are stored. When all email sent to the domain's MX record are captured (101) and passed off to the user's account (102), the email-parking system of the present invention runs a check to make sure that the domain of which the email had been sent is actually parked within the relevant system. Because of open relays and other issues relevant to an email system, this aspect serves to require that incoming emails pass this check. The system of the present invention will bounce the email if the domain name that the email was sent is not in the email parking system.

The present invention also takes into account the issue of spam emails. A conventional spam filter (103) will be used to filter the emails, and once passed, the emails will be sent to a content filter (104). The content filter of the present invention will strip the emails of all common words. The common words will be populated in a dictionary file, and when a common word is found and matched to the dictionary file, it is removed from the email. The types of words removed will be akin to “the,” “this”, “his”, “hers”, “a”, “that”, “where”, “is”, “as”, “because”, “it”, “him”, “she”, “you”, “me”, etc. After the content has been filtered as described above, keywords will remain that make up much of the main idea of the email. These keywords are then passed to and received by the keyword matcher (105). What happens here is that the content filter runs the remaining content—the keywords—through a dictionary database and assigns each keyword a numerical value. The preferred embodiment assigns each keyword one point, although a comparable system also can be used. Each keyword belongs to a category in the dictionary database. Once all the keywords are tallied up, the category that has the most keywords wins in terms of most points. This win means that a certain category for advertising will be relevant to that email based on the many instances of such keywords. The category information is then passed to the search terms (106).

Once the category information is passed to the search terms (106), the search terms matches the email parking system categories to the monetization provider's categories. In regard to advertisers, advertisements will be provided by a search engine (107). The search engine is a third party system that receives the email categories and then responds with a serious of advertisements. Once the system of the present invention receives the advertisements from the search engine, an advertising engine (108) combines the advertisements and formats them to go into the email. The advertisements are prepared and spaced correctly and then passed off to the targeted email generation (109). The targeted email generation (109) inserts predefined text to wrap as filler text around the advertisements. The filler text is a generic response to give the recipient of the email a greeting and point out that there are some targeted offers contained in the email which pertains to the information that was in the original email. It should be noted that when the email is generated, the address at which the original email address was received is populated into the “from” field. Once the email is generated, it is spooled and sent to the original sender of the email as outgoing mail (110).

From there, the user receives email and clicks on advertisement (111). The user will receive the email that has advertisements in it. The email also will have a number of clickable links that pertain to the body of the original message. Once the user clicks on the link in an email, the user is then taken to a page (112). This page is akin to an “offers” page and will be targeted to the original message. The page may be anywhere from an email submission to a free signup for an account, a purchase of a product or service, or any other action-based performance. When the user fulfils any necessary requirements for the offer, the user enters into a conversion process (113). This means that the user has bought the product or service, filled in their email address or have otherwise completed a requisite task. When this happens, the email is flagged which identifies the email and the domain name from which conversion process (113) originated and is then passed to the conversion tracking engine (114).

The conversion-tracking engine (114) receives the conversion information from the conversion process (113) and then deciphers from the information received. In the preferred embodiment, this includes the domain name that the original email was sent to, the offer that was converted, along with its monetary value, and the account number and perhaps owner of that account. Once all this information has been filtered out, the information then is passed back to the user's account (102). The final task relates to updating the statistics gleaned from this process. In the preferred embodiment, this includes the domain name that converted, the type of offer that converted, and the percentage of the money that the owner of the domain name is entitled to are all recorded and listed for the user to see.

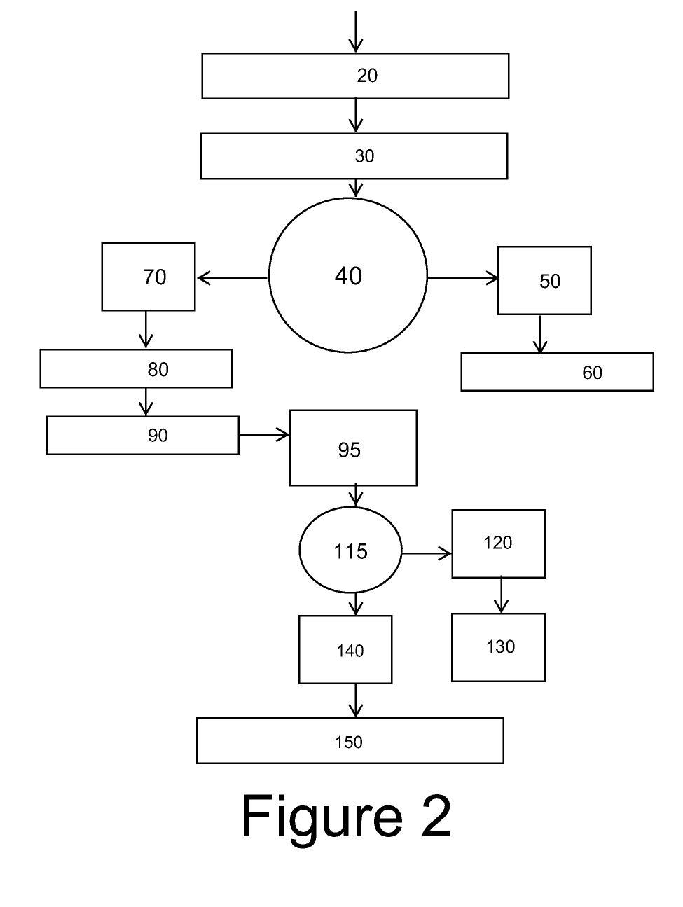

In FIG. 2, we see a flow chart of a preferred embodiment of a message processing method. A sending party generates an email message (10) that goes to a server (20). The server then relays the message to the intended recipient (30). At this point (40) two possibilities exist. Either the recipient's domain has not lapsed and been renewed by another person (50), in which case the email is successfully delivered (60) or the recipient's domain has lapsed and been renewed by another person (70), in which case the email is undeliverable as-is (80) and a catch-all account receives the message (90). At this point, the email parking system analyzes content of the sender's message (95) and first attempts to determine whether the email is Spam (115). If the parking system determines that the email is Spam (120), the message is discarded (130). If the parking system determines that the email is not Spam (140), then the email parking system matches contextual ads with the content of the sending party's message (150) and the server responds to the sending party with an automated email reply with targeted affiliate offers (160).

The present invention is a system for advertising. How it works is first by placing a mail exchange record of a domain name with an email parking platform, also referred to as the email parking system. Email messages to the mail exchange record are captured, where the email messages are then routed through the email parking platform. The email message is then passed to a user account and the email message is filtered. The system of the present invention then checks to ensure that the domain name of which the email message had been sent is actually parked with the email parking platform, the email message being bounced if the domain name is not within the email parking system. From there, the present invention sends the email message to a content filter such that the content filter is configured to strip the email message of common words. However, the system maintains keywords contained within the email message, the keywords containing the main idea of the sender of the email message. The keywords are passed to a keyword matcher, the keyword matcher configured to pass the keywords through a dictionary database where each of the keywords are assigned a value as described above and allocated to an advertising category within the dictionary database. The present invention also matches search terms to the advertising category to be monetized via a search engine. Advertisements are combined from an advertising engine with advertisements such that they are formatted to go into an outgoing mail by means of a targeted email generation.

An email message is generated from a sending party that goes to a server, where the system then relays the email message from the server to the intended recipient. Content of the email message is analyzed when the domain of the intended recipient has lapsed and consequently the email message is rendered undeliverable. The present invention also determines whether or not the email message is spam, and discards the email message if the email message is deemed to be spam. The present invention also matches contextual advertisements with the email message content of the sending party such that the server responds to the sending party with an automated email reply with targeted affiliate offers.

It also should be noted that the present invention stores the domain name that is currently being hosted on the email parking platform. It also records, changes and updates the mail exchange records at a registrar where the domain is registered or at a third party.

The present invention in an embodiment relates to a system that analyzes specific keywords from sent emails and assigns value to such keywords, which in turn compares the subject category that is most relevant to that email. From there, the present invention pulls advertisements from this subject category to include within the particular email. In this manner, the present invention tailors advertisements to individual sent emails based on the content contained within the email message. The present invention utilizes an untapped source of emails to effectively monetize them, while capturing and then monetizing emails that otherwise would have bounced if they were not parked within the domain system. Moreover, the present invention utilizes a domain's mail exchange (MX) record in such a manner that the MX records are recorded, changed, or updated at the registrar where the domain is registered, or at a third party system, and then pointed to the present invention.

Additional Anti-Spam Implementation

To assist in the tracking and prosecution of prolific spammers, the present invention in the preferred embodiment will have a hidden anchor tag that contains a “mailto” email address. The email address will contain a base64 encoded string for the “username” part of the email address at the domain name we are parking on the present invention. In the preferred embodiment, this will be achieved by the following format: base64 encoding (time stamp+client ip)@domain name.domain ext

This will mean that if an email arrives at this email address it would have only existed when the page was viewed and thus must have been scrapped since it could not have been opted-in or have been acquired by another process. The present invention will log these emails and will better enable the system to track spammers.

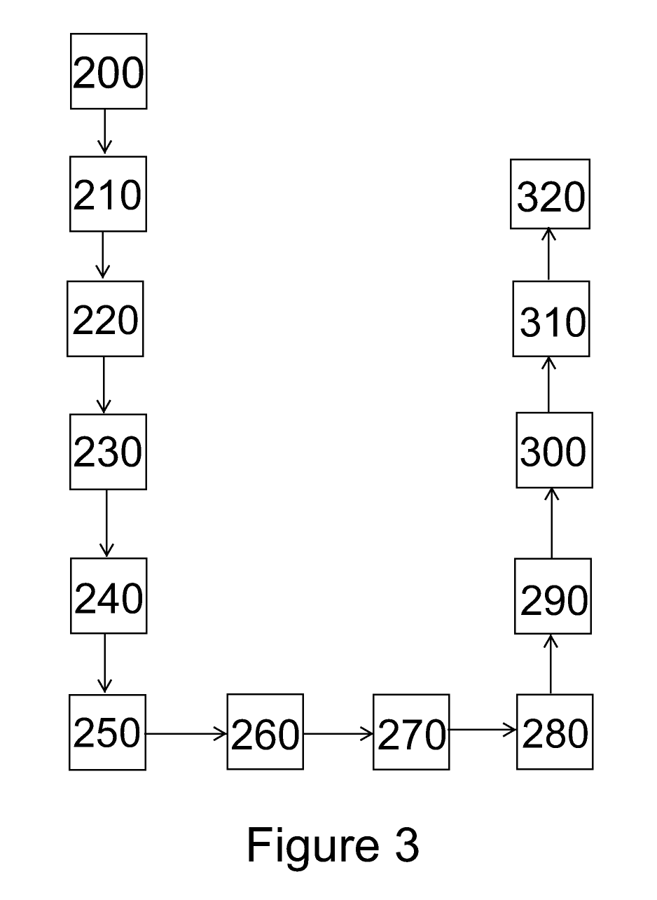

As we see in FIG. 3, the present invention utilizes misdirected emails as an avenue for monetization. Typically, Internet domain names are leased from the central registry. When the yearly lease on a domain name lapses, the domain name goes back into the available pool of domain names that can be registered by any other entity. When a new entity registers a domain name that had its registration lapse previously, sometimes the new registrant will receive emails meant for the former owner of the domain name. These emails are also referred to as misdirected emails.

In a lot of cases these misdirected emails will be bounced back to the original sender with a generic error message, or possibly no error or notification message at all.

The present invention utilizes these misdirected emails that a domain name receives as an avenue of monetization. The process for this monetization works as follows:

The MX record of a domain name is pointed to the present invention either via CNAME or an A record (200). These records will be pointing to the present inventions SMTP relay servers (210). Any emails that are sent to any email address on a domain name that is pointed to the present invention will trigger a notification of an incoming email on the invention (220). This includes the misdirected emails. The present invention will then trigger a bounce message via a series 550 error to announce to the original sender that there has been a problem getting the email to the intended recipient (230). Included in this series 550 error is a URL (240). Upon going to this URL in a web browser, the user browsing the page will be given additional information as to why the sending of the email message failed (250). If the present invention is able to provide it, the invention will give a detailed reason why the message failed to reach its intended destination (260). Also included in the URL will be the domain name itself (270). Once this special URL (along with the appended domain name) is inputted into a web browser, the user is taken to a web page that extrapolates the keywords in the domain name (280). Once the keywords of a domain name have been identified and extracted from the specialized URL that is created by the present invention (290), the keywords of the domain name are used as a special identifier for the advertisements that are placed in or around the website that the user is taken to (300). These advertisements are displayed in relationship to those keywords (310). With this implementation, related advertisements are shown in conjunction with what the original sender may have been emailing about (320).

I claim:

1. A system for advertising, comprising:
placing mail exchange record of a domain name with an email parking platform on a server;
capturing email messages to the mail exchange record;
routing the email messages through the email parking platform;
passing the email message to a user account;
filtering the email message;
checking to ensure that the domain name of which the email message had been sent is actually parked with the email parking platform, the email message being bounced if the domain name is not within the email parking system;
sending the email message to a content filter such that the content filter is configured to strip the email message of common words;
maintaining keywords contained within the email message, the keywords containing main idea of sender of the email message;
passing the keywords to a keyword matcher, the keyword matcher configured to pass the keywords through a dictionary database where each of the keywords are assigned a value and allocated to an advertising category within the dictionary database;
matching search terms to the advertising category to be monetized via a search engine; and
combining advertisements from an advertising engine with advertisements, such that they are formatted to go into an outgoing mail by means of a targeted email generation.

2. A system for advertising, comprising:
generating an email message from a sending party that goes to a server;
relaying the email message from the server to the intended recipient;
analyzing content of the email message when the domain of the intended recipient has lapsed and consequently the email message is rendered undeliverable;
determining whether or not the email message is spam; and
matching contextual advertisements with the email message content of the sending party such that the server responds to the sending party with an automated email reply with targeted affiliate offers.

3. The system for advertising of claim 1, further comprising storing the domain name that is currently being hosted on the email parking platform.

4. The system for advertising of claim 1, further comprising recording the mail exchange records at a registrar where the domain is registered.

5. The system for advertising of claim 1, further comprising changing the mail exchange records at a registrar where the domain is registered.

6. The system for advertising of claim 1, further comprising updating the mail exchange records at a registrar where the domain is registered.

7. The system for advertising of claim 4, further comprising recording the mail exchange records at a third party where the domain is registered.

8. The system for advertising of claim 1, further comprising recording the mail exchange records at a third party where the domain is registered.

9. The system for advertising of claim 2, further comprising discarding the email message if the email message is deemed to be spam.

10. A system for advertising, comprising:
pointing an MX record of a domain name;
triggering, on a computer, a notification of an incoming message when an email is sent to any email address on the domain name that is being pointed to by the MX record on a computer;
triggering a bounce message announcing to an original sender that there has been a problem getting the email to an intended recipient;
including a URL with the bounce message;
providing a user who clicks on the URL with additional information as to circumstances surrounding a failure of the email;
including the domain name within the URL;
using keywords of the domain name as an identifier for advertisements, the keywords having been identified and extracted from the URL; and
placing the advertisements in the Web site of which the user is taken, the advertisements displayed in relationship to the keywords.

11. The system of claim 10, further comprising pointing the MX record of the domain name to SMTP relay servers.

12. The system of claim 10, further comprising triggering the bounce message via a series 550 error.

13. The system of claim 10, further comprising providing detailed information as to the circumstances surrounding the email that failed to reach its intended destination.

14. The system of claim 10, further comprising taking a user to a Web page that extrapolates keywords in the domain name once the URL is inputted into a Web browser.

15. The system of claim 10, further comprising leasing the domain name from a central registry.

16. The system of claim 10, further comprising reverting the domain name into an available pool of domain names that can be registered by any other entity once a lease on the domain name lapses.

17. The system of claim 10, further comprising utilizing misdirected emails that are received by the domain name as an avenue of monetization.

18. The system of claim 1, further comprising pointing the MX record of the domain name to SMTP relay servers.

19. The system of claim 1, further comprising triggering the bounce message via a series 550 error.
